(19) United States
(12) Patent Application Publication
(10) Pub. No.: US 2013/0214071 A1
(43) Pub. Date: Aug. 22, 2013

(54) SINGLE-ROLLER AUTOMATIC PAPER FEEDING MECHANISM

(71) Applicant: Yu-Ching KAO, New Taipei City (TW)

(72) Inventor: Yu-Ching KAO, New Taipei City (TW)

(73) Assignees: TEX YEAR INDUSTRIES INC., New Taipei City (TW); Tex Year Business Machine(SHEN ZHEN)CO.LTD., Shenzhen (CN)

(21) Appl. No.: 13/400,137

(22) Filed: Feb. 20, 2012

(51) Int. Cl. B02C 23/02

(52) U.S. Cl. 241/34

(57) ABSTRACT

A single-roller automatic paper feeding mechanism disclosed by the present invention belongs to an office apparatus, comprising a supporting port, a paper feeding mechanism, and two cutters configured on the supporting part, a cover plate connected movably with the supporting part, a paper placing platform configured above the cutter, a sensor configured on the paper placing platform, wherein the paper feeding mechanism is a single roller group formed by connecting several rollers serially; also comprising a paper pressing plate connected with the cover plate, wherein an elastic pressing device is configured between them; also comprising a baffle which is configured on the paper placing platform and connected with it rotatably, wherein a hole capable of accommodating the baffle is configured at the place corresponding to the paper pressing plate surface contacting with the paper placing platform.

### BACKGROUND OF THE INVENTION

1. Technical Field

The present invention relates to a paper shredder, and more specifically, to a single-roller paper feeding mechanism only used on paper shredders.

2. Description of Related Art

As necessary office furniture, paper shredders are widely used in various workplaces. Most of the currently-used paper shredders consist of two roller groups which are configured parallel to the two side of the paper inlet and protrude from the paper placing platform so as to put a pile of paper on the paper placing platform. After closing the cover plate symmetrically opening left-to-right, the paper pressing device on the side of the cover plate presses on the top layer of the pile of paper by gravity and the bottom surface of lowest layer the pile of paper is driven by the two rotating rollers, causing the paper being brought into the paper inlet after being folded in half, and then being shredded and destroyed by the paper shredding device under the paper inlet. The use of the structure above is complex and of high production cost.

### BRIEF SUMMARY OF THE INVENTION

In view of this, the present invention aims at providing a single-roller automatic paper feeding mechanism with a single roller group capable of shredding waste paper smaller than standard size, which features a simple structure and low production cost.

To realize the purpose above, the technical solution used by the present invention is as follows: a single-roller automatic paper feeding mechanism, comprising a supporting port, a paper feeding mechanism and two cutters configured on the supporting part, a cover plate connected movably with the supporting part, a paper placing platform configured above the cutter, a sensor configured on the paper placing platform, wherein the paper feeding mechanism is a single roller group formed by connecting several rollers serially; a paper pressing plate connected with the cover plate, wherein an elastic pressing device is configured between them; and a baffle which is configured on the paper placing platform and connected with it rotatably, wherein a hole capable of accommodating the baffle is configured at the place corresponding to the paper pressing plate surface contacting with the paper placing platform; after installation, the cambered surface of the top of the roller is higher than the plane of the paper placing platform. The baffle is set to shred the waste paper smaller than standard size (A4).

Furthermore, the paper placing platform is divided into two parts which are on the two sides of the roller group respectively; the sensor is configured on the paper placing platform on one side of the roller group, the baffle is configured on the paper placing platform on the other side of the roller group, and the space between the two paper placing platforms is for the convenience of the deformed waste paper to go into the paper inlet.

Furthermore, the paper placing platform is under the paper pressing plate.

Furthermore, the paper inlet is between the two groups of cutters.

Furthermore, if the waste paper to be shredded is of standard size, the baffle and the paper placing platform is in the same plane; if the waste paper to be shredded is smaller than standard size, then the baffle is rotated to be vertical to the paper placing platform, so the upper end of the baffle is in the corresponding hole on the paper pressing paper after the cover plate is closed.

Furthermore, the two groups of cutters are installed parallel to each other and the rollers are above one group of the cutters.

Furthermore, the elastic pressing device comprises an upper end part, a connection column, a spring sleeved on the connection column, wherein the upper end of the connection column is connected firmly with the upper end part, the lower end is configured in the paper pressing plate and is inseparable with the paper pressing plate, namely the connection column can flex in the paper pressing plate.

Furthermore, the upper end part is fixed on the cover plate.

The favorable effects of the present invention are as follows: put a pile of waste paper on the paper placing platform, close the cover plate, wherein the cover plate is configured with a pressing device and a paper pressing plate, the motor will rotate when receiving the signal given by the sensor and drive the roller group to rotate, which will cause the friction between the rollers and the paper with the pressure given by the cover plate, paper pressing plate, and the elastic pressing device, thus bringing the paper into the paper inlet and being hooked and torn by the two groups of cutters located beneath, and in this way completing automatic paper shredding. If the paper is smaller than A4 size, then turn up the paper baffle, put the paper to be shredded at the front end of the baffle (namely the upward place of the roller group), and finish paper shredding as if shredding waste paper of standard size. Compared to the prior art, the present invention uses a single roller group to realize the automatic paper shredding function of two roller groups, which features simpler structure, lower production cost and capacity of shredding small-sized waster paper as well as various functions.

### BRIEF DESCRIPTION OF THE SEVERAL VIEWS OF THE DRAWINGS

FIG. 1 is the perspective view of the present invention;

FIG. 2 is the left view of the installation relationship between the paper feeding mechanism and paper shredding mechanism of the present invention;

FIG. 3 is the perspective view of the installation relationship between the paper feeding mechanism and paper shredding mechanism of the present invention;

FIG. 4 is the top view of the present invention in off working state;

FIG. 5 is the schematic diagram of the decomposition between the cover plate and the paper pressing plate.

Wherein, the figure marks are: 1—supporting part; 2—paper feeding mechanism; 3—cutters; 4—cover plate; 5—paper placing platform; 7—sensor; 8—baffle; 9—paper pressing plate; 10—elastic pressing device; 11—paper inlet; 12—motor; 51—indent; 91—hole; 101—upper end part; 102—connection column; 103—spring.

### DETAILED DESCRIPTION OF THE INVENTION

In order to enable the technical person in the art to understand the solution of the present invention, further description of the present invention will be given in conjunction with the drawings and embodiments.

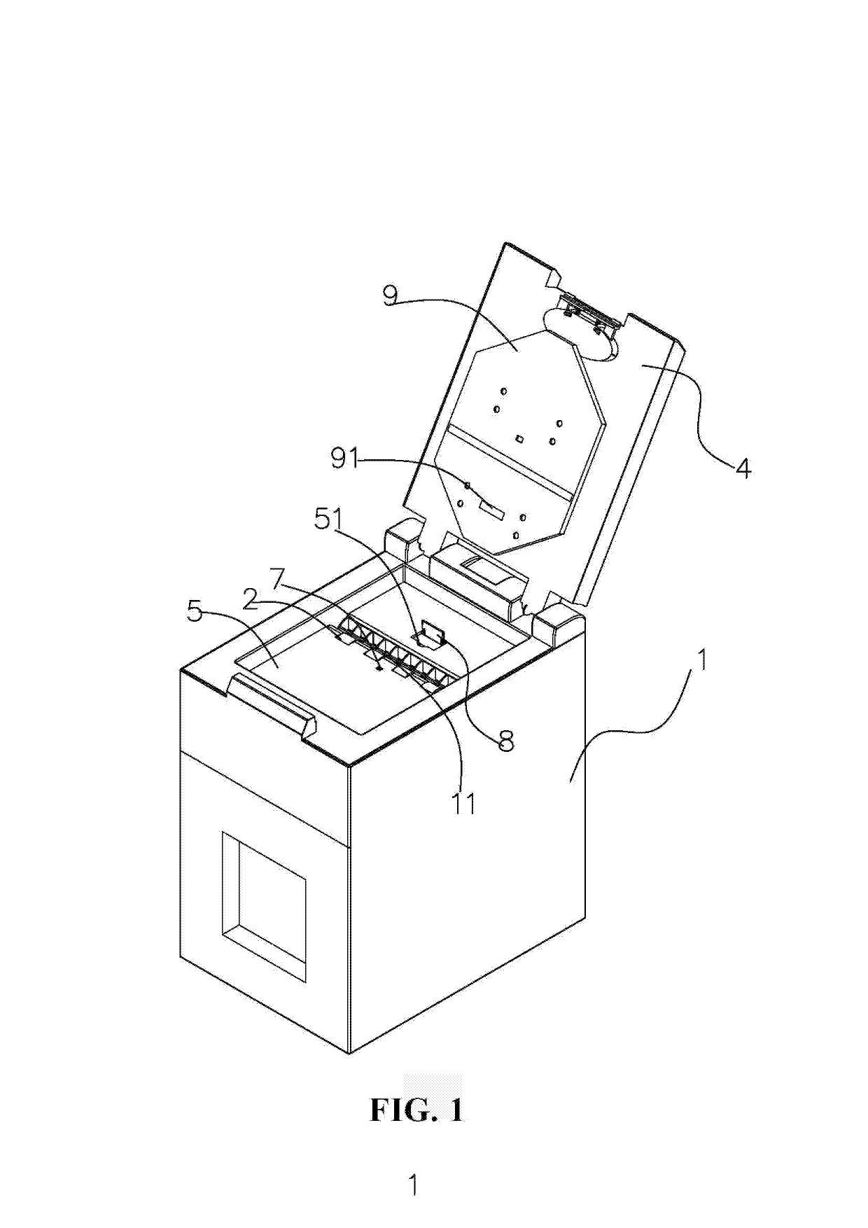

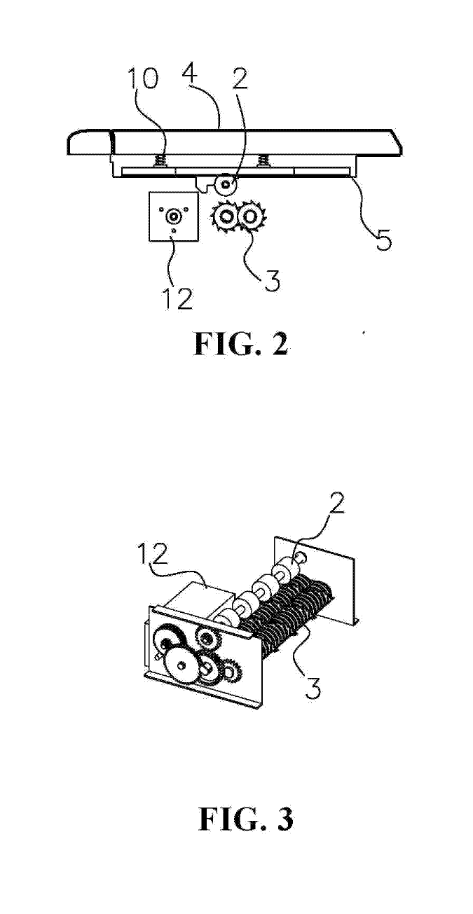

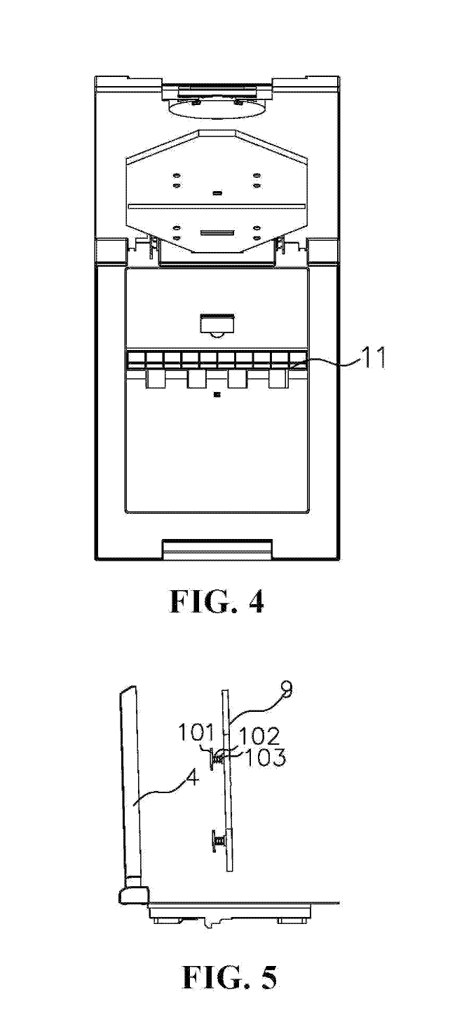

As shown in FIGS. 1-4, a single-roller automatic paper feeding mechanism is disclosed, comprising a supporting part 1, a paper feeding mechanism 2 and 2 groups of cutters 3 configured on the supporting part, a cover plate 4 connected movably with the supporting part 1 and a paper placing platform 5 configured above the cutters 3.

The paper feeding mechanism 2 is a single roller group formed by connecting several rollers serially; the paper placing platform 5 is divided into two parts which are on the two sides of the roller group respectively; a sensor 7 is configured on the paper placing platform on one side of the roller group, a baffle 8 is configured on the paper placing platform on the other side of the roller group and is connected with the paper placing platform rotatably, the paper placing platform is configured with a cambered indent 51 located in front of the baffle 8 so as to open the baffle 8, and the space between the two paper placing platform is for the convenience of the deformed waste paper to go into the paper inlet.

It also comprises a paper pressing plate 9 connected with the cover plate 4, an elastic pressing device 10 between them, a hole 91 capable of accommodating the baffle 8 configured at the place corresponding to the paper pressing plate 9 surface contacting with the paper placing platform 5; corresponding to the paper placing platform, the paper placing plate 9 also consists of two parts.

After installation, the cambered surface of the top of the roller is higher than the plane of the paper placing platform, so as to contact closely with the paper pressing plate 9, and the friction between it and the waste paper to be shredded cause the waster protruded into the paper inlet 11 after deformation, wherein the paper inlet 11 is located between the two groups of cutters 3.

The effect of the configuration of the baffle 8 is that, if the waste paper to be shredded is of standard size (A4), the baffle 8 and the paper placing platform 5 is in the same plane; if the waste paper to be shredded is smaller than standard size, then the baffle 8 is rotated to be vertical to the paper placing platform 5, so the upper end of the baffle 8 is in the corresponding hole 91 on the paper pressing paper after the cover plate 4 is closed.

The two groups of cutters 3 are installed parallel to each other and the rollers are above one group of the cutters.

As shown in FIG. 5, the specific structure is used to illustrate the connection relationship between the cover plate 4 and the paper pressing plate 9, and the elastic pressing device 10, wherein the elastic pressing device 10 comprises an upper end part 101, a connection column 102, a spring 103 sleeved on the connection column, the upper end of the connection column 102 is connected firmly with the upper end part 101, and its lower end is configured in the paper pressing plate 9 and inseparable with the paper pressing plate 9, namely the connection column 102 can flex in the paper pressing plate; the upper end part 101 is fixed on the cover plate 4.

The working principal of the present invention is as follows: put a pile of waste paper on the paper placing platform 5, close the cover plate 4, wherein the cover plate 4 is configured with an elastic pressing device 10 and a paper pressing plate 9, the motor 12 will rotate when receiving the signal given by the sensor 7 and drive the roller group to rotate, which will cause the friction between the rollers and the paper with the pressure given by the cover plate 4, paper pressing plate 9 and the elastic pressing device 10, thus bringing the paper into the paper inlet 11 and being hooked and torn by the two groups of cutters 3 located beneath, in this way completing automatic paper shredding. If the paper is smaller than A4 size, then turn up the paper baffle 8, put the paper to be shredded at the front end of the baffle 8, namely the upper area of the roller group and finish paper shredding as if shredding the waste paper of standard size. Compared to the prior art, the present invention uses a single roller group to realize the automatic paper shredding function of two roller groups, which features a simpler structure, low production cost and the capacity of shredding small-sized waste paper as well as various functions.

The description above is only to illustrate the preferred embodiments but not to limit the protection scope of the present invention. Any changes and alternations in the technical scope disclosed by the invention that can be easily thought out by the technical personnel skilled in the technical art shall be covered in the protection scope of the present invention. Therefore, the protection scope of the present invention shall be subject to the Claims.

What is claimed is:

1. A single-roller automatic paper feeding mechanism, comprising a supporting port, a paper feeding mechanism and two cutters configured on the supporting part, a cover plate connected movably with the supporting part, a paper placing platform configured above the cutter, a sensor configured on the paper placing platform, characterized in that the paper feeding mechanism is a single roller group formed by connecting several rollers serially; also comprising a paper pressing plate connected with the cover plate, wherein an elastic pressing device is configured between them; also comprising a baffle which is configured on the paper placing platform and connected with it rotatably, wherein a hole capable of accommodating the baffle is configured at the place corresponding to the paper pressing plate surface contacting with the paper placing platform; after installation, the cambered surface of the top of the roller is higher than the plane of the paper placing platform.

2. The single-roller automatic paper feeding mechanism according to claim 1, characterized in that the paper placing platform is divided into two parts which are on the two sides of the roller group respectively; a sensor is configured on the paper placing platform on one side of the roller group and a baffle is configured on the paper placing platform on the other side of the roller group.

3. The single-roller automatic paper feeding mechanism according to claim 1, characterized in that the paper placing platform is under the paper pressing plate.

4. The single-roller automatic paper feeding mechanism according to claim 1, characterized in that the paper inlet is between the two groups of cutters.

5. The single-roller automatic paper feeding mechanism according to claim 1 or 2, characterized in that, if the waste paper to be shredded is of standard size, the baffle and the paper placing platform is in the same plane; if the waste paper to be shredded is smaller than standard size, then the baffle is rotated to be vertical to the paper placing platform, so the upper end of the baffle is in the corresponding hole on the paper pressing paper after the cover plate is closed.

6. The single-roller automatic paper feeding mechanism according to claim 1, characterized in that the two groups of cutters are installed parallel to each other and the rollers are above one group of the cutters.

7. The single-roller automatic paper feeding mechanism according to claim 1, characterized in that the elastic pressing device comprises an upper end part, a connection column, a sleeved spring on the connection column, wherein the upper end of the connection column is connected firmly with the upper end part, the lower end is configured in the paper pressing plate and is inseparable with the paper pressing plate, namely the connection column can flex in the paper pressing plate.

8. The single-roller automatic paper feeding mechanism according to claim 1 or 7, characterized in that the upper end part is fixed on the cover plate.
